(19) United States
(12) Patent Application Publication
(10) Pub. No.: US 2005/0155627 A1
(43) Pub. Date: Jul. 21, 2005

(54) SPILL CLEANING DEVICE WITH BUILT-IN SQUEEGEE

(75) Inventors: Andrew M. Bober, Racine, WI (US); Jay Hutchison, Racine, WI (US); James M. Scolaro, Racine, WI (US)

Correspondence Address: S.C. JOHNSON COMMERCIAL MARKETS INC, 8310 16TH STREET, M/S 510, PO BOX 902, STURTEVANT, WI, 53177-0902, US

(73) Assignee: JOHNSONDIVERSEY, INC., Sturtevant, WI (US)

(21) Appl. No.: 10/707,893

(22) Filed: Jan. 21, 2004

(51) Int. Cl. B08B 1/00

(52) U.S. Cl. 134/6; 15/104.001; 15/236.1; 134/42

(57) ABSTRACT

A device for use when there is a spill including a spill cleaning device which can collect liquid and solid debris from a surface. The spill cleaning device includes at least one squeegee. The spill cleaning device further includes a sachet member containing a cleaner and/or a sanitizer to clean the surface after the debris is collected. The spill cleaning device is designed for simple operation and to eliminate the need for multiple items to clean a spill.

### BACKGROUND OF INVENTION

### TECHNICAL FIELD

This invention relates to a spill cleaning device which may be used to collect liquid and solid debris. More particularly, it relates to a cleaning pad with an attached squeegee so that solid debris can be collected and any liquid debris can be absorbed effectively eliminating the need for multiple items to clean-up a spill. The spill cleaning device may also include a sachet member containing various liquids to clean or sanitize the spill area after the debris is removed.

Cleaning pads are well-known. These are disclosed in U.S. Pat. No. 3,221,351.

Cleaning sheets with rupturable liquid cleaner containing capsules are disclosed in U.S. Pat. Nos. 4,929,214 and 2,980,941.

Automobile windshield cleaning devices with a squeegee are disclosed in U.S. Pat. Nos. 4,807,322 and 6,092,255.

The prior art does not provide a spill cleaning device with only a squeegee device. Neither does it provide a spill cleaning device with a squeegee which is adapted to clean and/or sanitize a spill area by including a rupturable sachet member containing liquid.

There is a need for a spill cleaning device to be able to collect any solid debris that may be intermingled with any liquid debris. Spills of this type frequently occur in stores and particularly those which provide products which contain liquids and when dropped results in liquid and solid debris. This is a hazardous condition for shoppers and for workers who must handle the solid debris with their hands in order to remove it and then separately absorb the liquid debris. Also there is a need for a spill cleaning device which is meant for a single use then can be replaced so that there is no cross contamination or any need to clean the spill cleaning device after its use. Not only is a spill cleaning device with a squeegee beneficial, it is even more useful if it is combined with a sachet member that contains sanitizing or cleaning liquid so the area of the spill can be cleaned with the same pad.

The objects of the invention therefore are:
a) Providing a disposable spill cleaning device that can collect liquid and solid debris.
b) Providing a disposable spill cleaning device of the foregoing type which is able to collect solid and liquid spills and the cleaning of the spill area without the need for separate steps.
c) Providing a disposable spill cleaning device of the foregoing type which includes a breakable sachet member that contains cleaning and/or sanitizing liquid.
d) Providing a replaceable spill cleaning device of the foregoing type which is replaced after each use.

### SUMMARY OF INVENTION

The foregoing objects are accomplished and the shortcomings of the prior art are overcome by the replaceable spill cleaning device of this invention which in one embodiment includes a cleaning pad member, which may be made of an absorbent material, with at least one squeegee member and at least one a sachet member connected to the cleaning pad member. The spill cleaning device may also include an attachment member. The spill cleaning device has at least one squeegee member connected to the cleaning pad member. At least one sachet member containing a liquid is present within or attached to the cleaning pad member. The sachet member is constructed and arranged to be breakable when pressure is applied to the spill cleaning device. An attachment member is constructed and arranged to support the spill cleaning device allowing for use of the cleaning pad member, the squeegee member and sachet member in combination or separately.

In one embodiment, the cleaning pad member of the spill cleaning device has at least one squeegee member, but preferable two squeegee members attached to the cleaning pad member with a sachet member positioned behind a single squeegee member or between the two or more squeegee members. The sachet member is within the cleaning pad member or attached thereto. The spill cleaning device further has a joining means to attach to an attachment member.

In another embodiment, the cleaning pad member has at least one squeegee member where the squeegee member is concave in shape and is attached to the front of the cleaning pad member. The squeegee member extends above the cleaning pad member and is arranged in such a way to allow for the collection of debris. The spill cleaning device further has a sachet member within the cleaning pad member or attached thereto in the portion following the squeegee member. This embodiment in addition may have a second squeegee member attached to the cleaning pad member after the sachet member.

In the preferred embodiment, the cleaning pad member is made of an absorbent material and is pliable which may be folded onto the attachment member and the one side has at least one squeegee member attached and on the opposite side the pad contains at least one sachet member. The spill cleaning device when attached to the attachment member with a pivoting head member on which the spill cleaning device is folded at approximately a ninety degree angle allowing for the use of the squeegee member without the sachet member contacting the surface then the head is pivoted and the sachet member is put on the surface and ruptured to emit a liquid.

These and still other objects and advantages of the invention will be apparent from the description which follows. In the detailed description below, a preferred embodiment of the invention will be described in reference to the full scope of the invention. Rather, the invention may be employed in other embodiments.

### BRIEF DESCRIPTION OF DRAWINGS

FIG. 1 is a front perspective view of the spill cleaning device engaged with the attachment member with the sachet portion down and ruptured.

FIG. 2 is a front view of the spill cleaning device engaged with the attachment members with the squeegee portion down.

FIG. 3 is a top view of the spill cleaning device.

FIG. 4 is a view similar to FIG. 2 illustrating the spill cleaning device engaged with the attachment member with the sachet portion in a position to engage a surface.

FIG. 5 is a bottom view of the spill cleaning device engaged with the attachment member with the sachet portion down.

FIG. 6 is a partial cross sectional view of the spill cleaning device engaged with the attachment member with the sachet portion down.

FIG. 7 is a partial cross sectional view of the spill cleaning device engaged with the attachment member with the squeegee portion down.

FIG. 8 is a bottom view of another embodiment of the spill cleaning device.

FIG. 9 is a top view of the spill cleaning device of the embodiment of FIG. 8.

FIG. 10 is a side view of the spill cleaning device of the embodiment of FIG. 8.

FIG. 11 is a cross sectional side view of the spill cleaning device of the embodiment of FIG. 8.

FIG. 12 is a side view of the preferred embodiment engaged with the attachment member with the squeegee portion down.

FIG. 13 is a side view of the preferred embodiment engaged with the attachment member with the sachet portion down.

FIG. 14 is top view of the preferred embodiment without the attachment means.

FIG. 15 is a cross sectional view of the preferred embodiment at line A of FIG. 14

### DETAILED DESCRIPTION

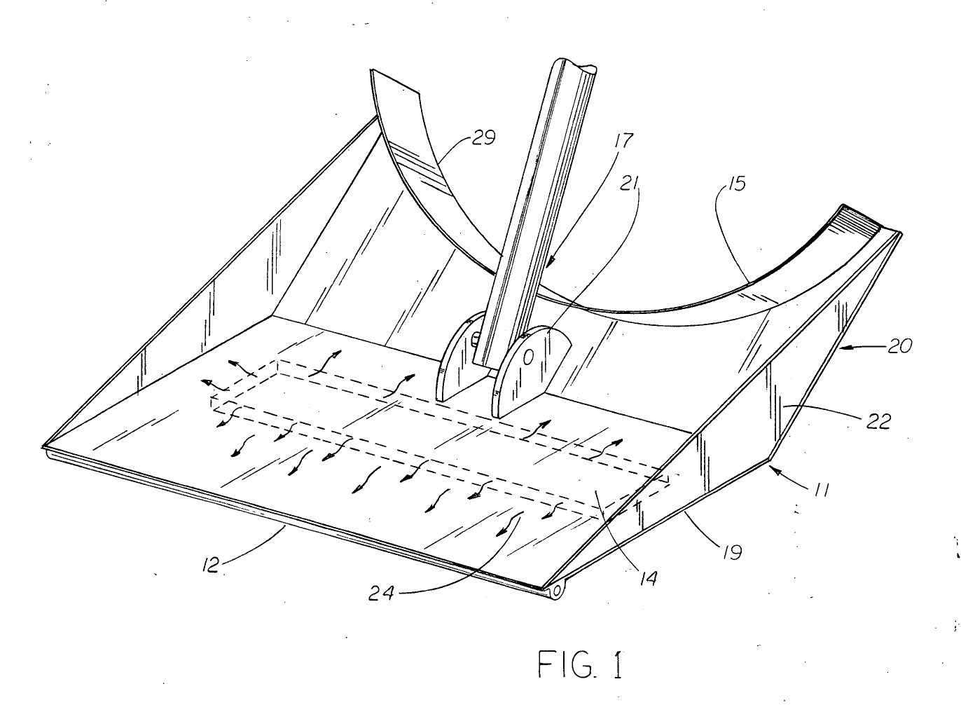

FIG. 1 illustrates one embodiment of a spill cleaning device 11 including a cleaning pad member 12 with at least one squeegee member 25 and at least one sachet member 14 connected to said cleaning pad member 12. The sachet member 15 is within or attached to the cleaning pad member 12 of the spill cleaning device 11. FIG. 1 shows the spill cleaning device 11 generally engaged with an attachment member 17 generally. The attachment member 17 has a pivoting head 21 wherein the spill cleaning device 11 is positioned to have the sachet member 14 in contact with a surface and ruptured to release the sachet member contents 24 which may be a cleaning and/or sanitizing substance that may be a liquid. FIG. 1 shows a concave shaped squeegee member 15 not in use that is attached to a front portion 29 of the cleaning pad member 12 and extends above the cleaning pad member 12.

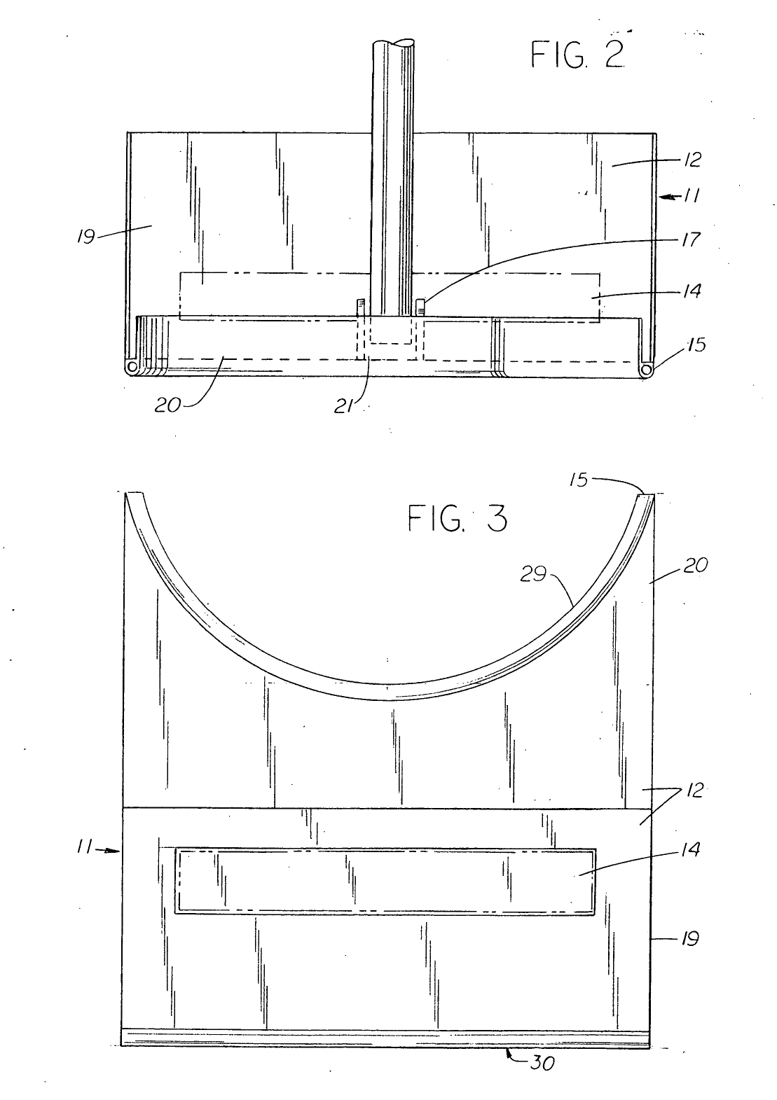

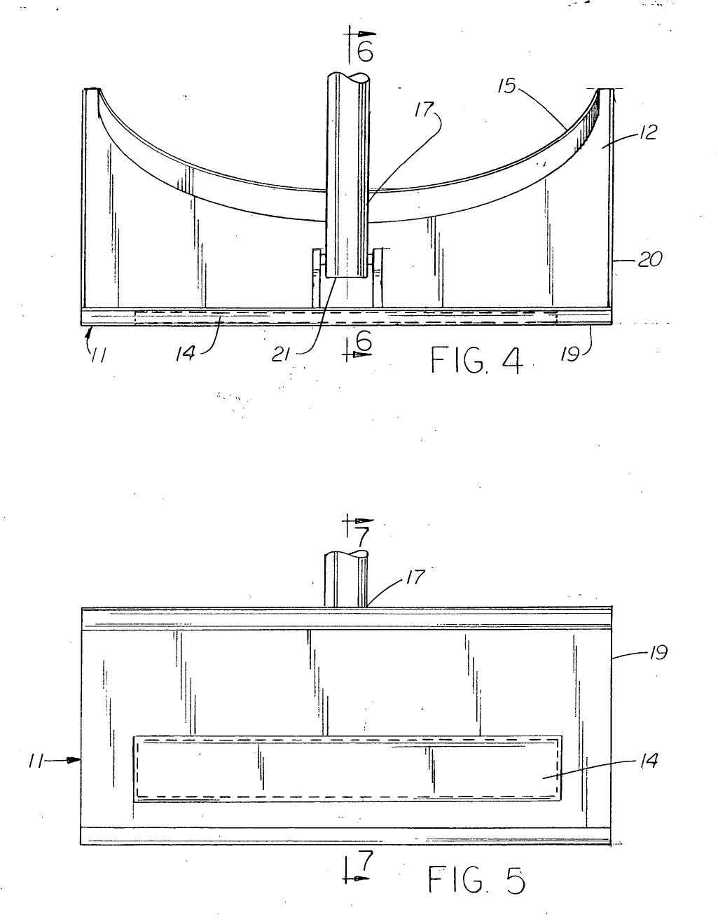

FIGS. 2, 4 and 5 are views of the same embodiment as show in FIG. 1 of the spill cleaning device 11 generally engaged with attachment member 17 having a pivoting head 21. FIG. 2 shows a front view of the spill cleaning device 11 generally engaged with the attachment member 17 where the squeegee portion generally 20 is in the position to be engaged with a surface. FIG. 4 shows the spill cleaning device 11 generally engaged with the attachment member 17 where in the sachet portion 19 is in the position to be engaged with a surface. FIG. 5 shows a bottom view of the spill cleaning device 11 generally engaged with the attachment member 17 where the sachet portion 19 is in the position to not engage a surface.

FIG. 3 is a top view of the same embodiment as above of the spill cleaning device 11 wherein the sachet member 19 is shown attached to the cleaning pad member 12. FIG. 3 further shows a top view of the concave shape of the squeegee member 15.

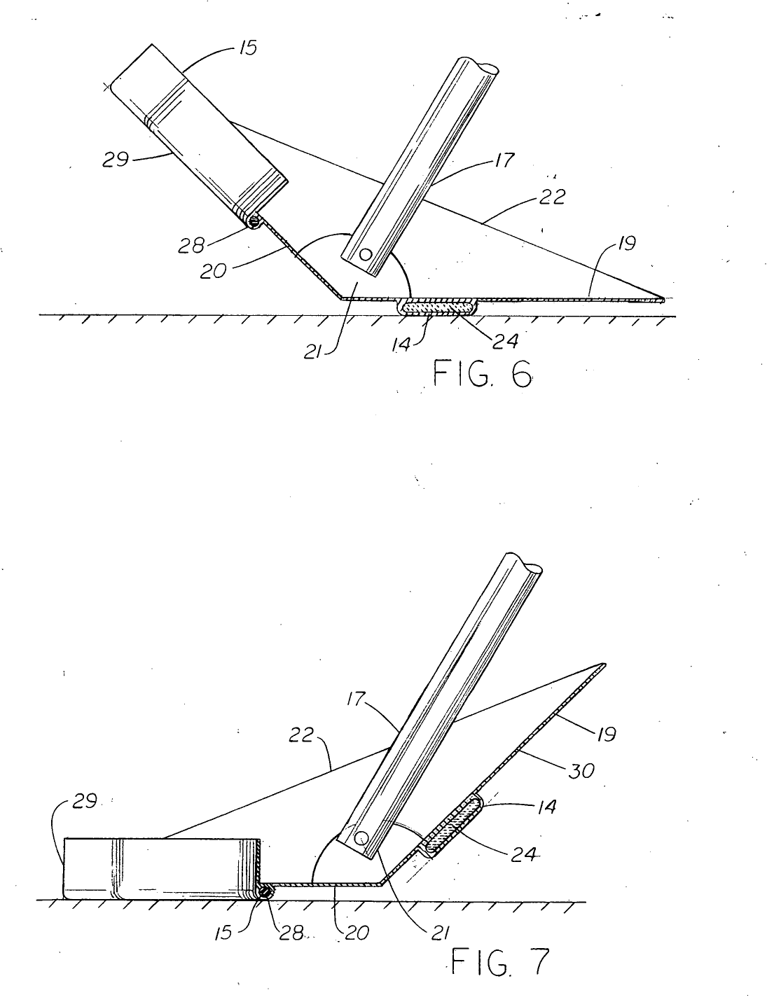

FIGS. 6 and 7 show the same embodiment as above in a cross sectional view of the spill cleaning device 11 generally engaged with the attachment member 17 wherein the squeegee member 15 has a cylindrical portion 28 and may be made of a natural or synthetic rubber material.

FIG. 6 shows the spill cleaning device 11 engaged with the pivoting head 21 of the attachment member 17 with the sachet portion 19 in used. The sachet member 14 is in contact with the surface 25 and the sachet member 14 within the cleaning pad member 12 has not been ruptured to release the sachet member contents 24. FIG. 7 shows the spill cleaning device 11 engaged with the pivoting head 21 of the attachment member 17 with the concave squeegee member 15 in use.

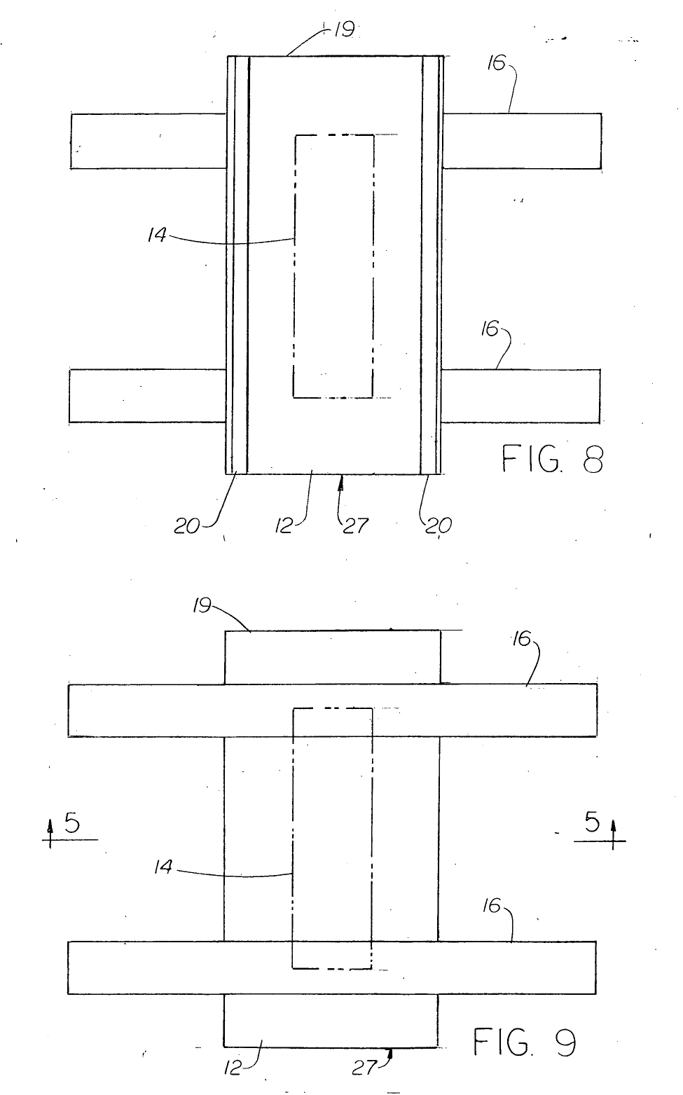

FIGS. 8 and 9 are the top and bottom view respectively of another embodiment of the spill cleaning device 27 with the attachment means 16 in the form of two straps 23 not engaged. The attachment means 16 of the spill cleaning device 27 may be straps 23 made of Velcro. The same reference numerals are employed to designate the same or similar parts as employed in conjunction with other embodiments of the spill cleaning device 11. The spill cleaning device 27 has two squeegee members 15 with a sachet portion 19 and a sachet member 14 between the two squeegee members 15. The sachet member 14 is within the cleaning pad member 12 and the squeegee members 15 are attached to the bottom of the cleaning pad member 12 and extends the length of the cleaning pad member 12.

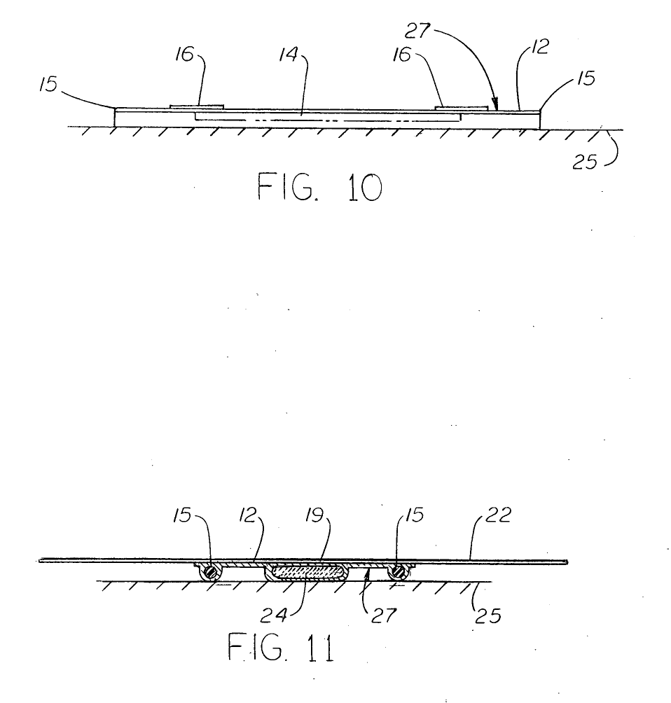

FIGS. 10 and 11 are a side and cross sectional view respectfully of the embodiment of the spill cleaning device 27 of FIGS. 8 and 9. FIG. 10 shows the side view of the spill cleaning device 27 engaged with the surface 25 where the sachet member 14 has not been ruptured. The cleaning pad member 12 is comprised of an absorbent material and/or a non-woven fabric. There are two squeegee members 15 that are in contact with a surface 25 with one embodiment of the attachment means 16 shown when not in use. FIG. 11 is a cross sectional view where spill cleaning device 27 is engaged with the head 22 of the attachment member 17. It shows the sachet member 14 is not ruptured with the sachet member contents 24 still intact. The squeegee members 15 are in contact with the surface 25 while the cleaning pad member 22 is not in contact with the surface 25 allowing for the removal of solid debris.

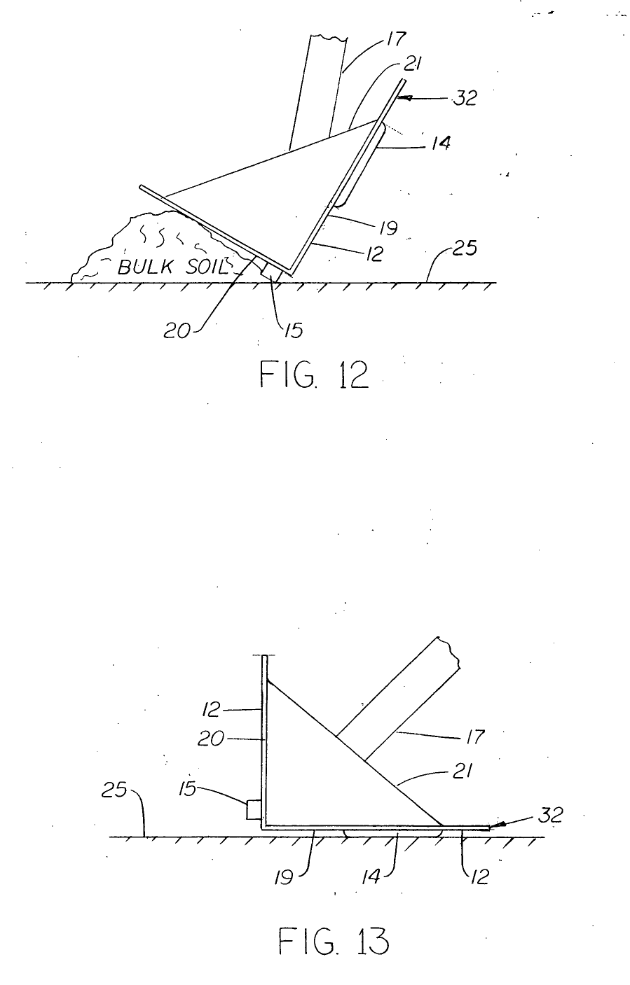

FIGS. 12 and 13 are side views of the preferred embodiment of the spill cleaning device generally 32 FIG. 12 shows the spill cleaning device 32 engaged with the attachment member 17 and the squeegee portion 20 and the squeegee member 15 are engaged with the surface 25. The same reference numerals are employed to designate the same or similar parts as employed in conjunction with other embodiments of the spill cleaning device 11 and 27. The sachet member 14 and sachet portion 19 are up and are not in contact with the surface 25 this allows for collection of the spill debris with out the rupturing of the sachet member 14. Subsequently the user can control when the sachet member contents 24 are released for cleaning or sanitizing the surface.

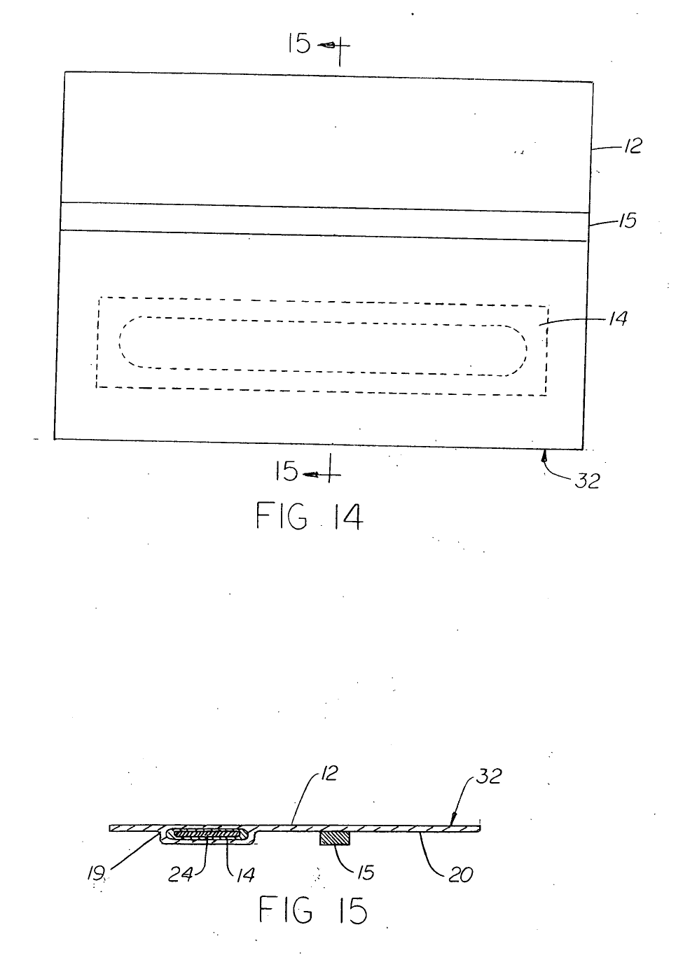

FIGS. 14 and 15 are of the preferred embodiment of the spill cleaning device 32 in a plan view and a cross sectional view. The spill cleaning device 32 shows the sachet member 14 and the squeegee member 15. The sachet member 14 is within the cleaning pad member 12 and the squeegee member 15 is attached to the cleaning pad member 12. FIG. 15 shows a cross sectional view wherein the sachet member 14 is shown in tact with the sachet member contents 24 inside. Also there is the squeegee member 15 attached to the cleaning pad member 12.

The invention further includes a method of absorbing a spill on a surface 25 wherein the spill and the surface are cleaned with a single device employing any embodiments of the spill cleaning device 11, 27 or 32. The method of absorbing a spill on a surface 25 and cleaning the surface 25 with a single device comprises the placement of a cleaning pad member 12 with at least one squeegee member 15 and at least one sachet member 14 on spill. The spill cleaning device 11, 27 or 32 is placed on the surface 25 then moved toward the spill with the squeegee member 15 forward to collect all solid debris then collecting the liquid debris with the cleaning pad member 12. The cleaning device 11, 27 or 32 is then generally adjusted so that the sachet portion 19 is in contact with the surface 25 and the sachet member 14 is ruptured allowing the releases of the sachet member contents 24 and the sachet portion 19 is then used to collect excess sachet member contents 24 and clean the surface 25.

In the method described above employing the spill cleaning device 11, 27 or 32 a sachet member 14 may be included wherein the sachet member contents 24 may be a cleaning and/or a sanitizing liquid which when ruptured releases the cleaning and/or sanitizing solution to cleaning the surface 25 with the cleaning pad member 12 once the spill debris is removed.

As indicated previously the spill cleaning device 11, 27 or 32 of the method may include two squeegee members 15 one in front of the squeegee portion 20 and one at the front of the sachet portion 19. The method includes employing two or more squeegee members 15 with an attachment member 17 which has a pivotal head 21 that allows for the use of the sachet portion 19 separately from the use of the squeegee portion 20 there by allowing for the cleaning of the spill debris with the cleaning pad member 12 constructed of an absorbent material which may be non-woven material to collect the liquid debris and the squeegee member 15 may be made of a natural or synthetic rubber in order to collect the solid debris. The pivotal head 21 is pivoted so the sachet portion 19 is in contact with the surface 25 allowing for the sachet member 14 to be ruptured thereby releasing the sachet member contents 24 to clean and/or sanitize the surface 25.

1. A spill cleaning device comprising:
a cleaning pad member;
at least one squeegee member connected to said cleaning pad member and
at least one sachet member connected to said cleaning pad member.

2. A spill cleaning device of claim 1 wherein the cleaning pad member is comprised of an absorbent material.

3. A spill cleaning device of claim 1 further including an attachment means.

4. A spill cleaning device of claim 1 wherein the cleaning pad member is made from a non-woven fabric.

5. A spill cleaning device of claim 1 wherein the sachet member is attached to the cleaning pad member.

6. A spill cleaning device of claim 1 wherein the sachet member is within the cleaning pad member.

7. A spill cleaning device of claim 1 wherein the sachet member contains a liquid.

8. A spill cleaning device of claim 7 wherein the liquid in the sachet member is a sanitizing liquid.

9. A spill cleaning device of claim 7 wherein the liquid in the sachet member is a cleaner.

10. A spill cleaning device of claim 1 wherein the squeegee member is attached to the cleaning pad member.

11. A spill cleaning device of claim 1 wherein the squeegee member is made of a natural or synthetic rubber material.

12. A spill cleaning device of claim 1 wherein the squeegee member is attached to a front of the cleaning pad member.

13. A spill cleaning device of claim 12 wherein the squeegee member is concave in shape.

14. A spill cleaning device of claim 12 wherein the squeegee member extends above the cleaning pad member.

15. A spill cleaning device of claim 1 wherein at least one squeegee member is attached to the bottom of the cleaning pad member.

16. A spill cleaning device of claim 15 wherein the squeegee member extends the length of the cleaning pad member.

17. A spill cleaning device of claim 16 wherein the squeegee member includes a cylindrical portion.

18. A spill cleaning device of claim 3 engaged with an attachment member.

19. A spill cleaning device of claim 18 wherein the attachment member includes a head.

20. A spill cleaning device of claim 19 wherein the attachment member has a pivoting head.

21. A spill cleaning device of claim 19 wherein the cleaning pad member is engaged with the head.

22. A spill cleaning device comprising:
a cleaning pad member;
at least two squeegee members connected to said cleaning pad member and
at least one sachet member connected to said cleaning pad member.

23. A spill cleaning device of claim 22 wherein the cleaning pad member is comprised of an absorbent material.

24. A spill cleaning device of claim 22 wherein the squeegee members are attached to the cleaning pad member.

25. A spill cleaning device of claim 22 wherein the squeegee members are made of a natural or synthetic rubber material.

26. A spill cleaning device of claim 22 wherein one squeegee member is attached to the front of the cleaning pad member and a second squeegee member is attached to the back of the cleaning pad member.

27. A spill cleaning device of claim 25 wherein the squeegee member is concave in shape.

28. A spill cleaning device of claim 27 wherein the concave squeegee member extends above the cleaning pad member.

29. A spill cleaning device of claim 22 wherein the squeegee members are attached to the bottom of the cleaning pad member.

30. A spill cleaning device of claim 29 wherein the squeegee members extend the length of the cleaning pad member.

31. A spill cleaning device of claim 29 wherein the squeegee members including a cylindrical portion.

32. A spill cleaning device of claim 29 wherein the sachet member is positioned between the squeegee members.

33. A method of absorbing a spill on a surface and cleaning the surface with a single device employing the spill cleaning device of claim 1.

34. A method of absorbing a spill on a surface and cleaning the surface with a single device comprising:
placing a cleaning pad member with at least one squeegee and at least one sachet member on a surface with a spill;
moving the device toward the spill with the squeegee member positioned forward to collect solid debris; and
collecting the liquid debris with the cleaning pad member.

35. The method of claim 34 wherein the spill cleaning device includes a sachet member that contains a cleaning liquid which when activated releases a cleaning solution to clean the surface once the spill is removed.

36. The method of claim 34 wherein the spill cleaning device includes a sachet member that contains a sanitizing liquid which when activated releases a cleaning solution to clean the surface once the spill is removed.

37. The method of claim 34 wherein the spill cleaning device includes at least two squeegees one in a front portion of the cleaning pad member and one at a back portion of the cleaning pad member.

38. The method of claim 37 wherein the spill cleaning device includes a sachet member positioned between the squeegees.

39. The method of claim 34 wherein the spill cleaning device is engaged with an attachment member to be used in conjunction with the device to clean a spill off a surface.

40. The method of claim 39 wherein the attachment member has a pivoting head to engage the spill cleaning device.

41. The method of claim 40 wherein the spill cleaning device is engaged with the pivotal head of the attachment member forming an angle wherein a squeegee portion is on one side of the pivoting head and a sachet portion is on the other side of the pivitol head;
placing the spill cleaning device on the surface and moving the device toward the spill with the squeegee member forward to collect all solid debris;
collecting the liquid debris with the cleaning pad member;
pivoting the pivotal head of the attachment member to allow the sachet portion to contact the surface and rupture the sachet portion to release a contained material of the sachet member on the surface; and collecting the contents with cleaning pad member.

42. The method of claim 41 wherein the contained materials of the sachet member is a cleaner.

43. The method of claim 41 where in the contained materials of the sachet member is a sanitizer.
